(19) United States
(12) Patent Application Publication
(10) Pub. No.: US 2023/0113433 A1
(43) Pub. Date: Apr. 13, 2023

(54) HYDROGEN SULFIDE ADSORPTION PROCESS AND APPARATUS

(71) Applicant: FRESHAIR SENSOR LLC, Lebanon, NH (US)

(72) Inventors: Andrei Burnin, West Lebanon, NH (US); Katherine Shelton, Lebanon, NH (US); Hyungdon Joo, Lebanon, NH (US); Matthew Curtin, Hanover, NH (US); Joseph J. BelBruno, Hanover, NH (US)

(21) Appl. No.: 17/962,368

(22) Filed: Oct. 7, 2022

Related U.S. Application Data
(60) Provisional application No. 63/253,987, filed on Oct. 8, 2021.

(51) Int. Cl. B01J 20/06; B01J 20/02; B01J 20/26; B01J 20/10; B01J 20/20; B01J 20/28; B01D 53/04; C02F 3/28; C02F 1/28

(52) U.S. Cl. CPC B01J 20/06; B01J 20/0229; B01J 20/0285; B01J 20/0288; B01J 20/0237; B01J 20/0244; B01J 20/261; B01J 20/103; B01J 20/20; B01J 20/28004; B01J 20/28016; B01J 20/28059; B01J 20/28061; B01J 20/28064; B01J 20/2805; B01D 53/0454; B01D 53/0415; C02F 3/28; C02F 1/281; B01D 2253/1128; B01D 2253/304; B01D 2253/306; B01D 2257/304; B01D 2257/406; B01D 2257/708; C02F 2101/101

(57) ABSTRACT

An adsorbent composition for capturing pollutants includes a porous composition that includes a plurality of ferric oxyhydroxide particles and an additional component in the porous composition. The additional component includes one of copper chloride (CuCl₂), zinc chloride (ZnCl₂), polyvinylpolypyrrolidone, silicon carbide, silicon dioxide, activated carbon or other carbonaceous material, and a combination thereof.

### CROSS-REFERENCE TO RELATED APPLICATIONS

This application claims the benefit of priority from U.S. Provisional Application No. 63/253,987 filed Oct. 8, 2021, which is herein incorporated by reference in its entirety.

### BACKGROUND

Hydrogen sulfide (H₂S) is a colorless, flammable gas that can be toxic if inhaled. The sulfur-like odor is easily recognized at lower concentration, but higher concentrations result in olfactory insensitivity. The United States Occupational Safety and Health Administration establishes worker exposure limits on the permissible amount of hydrogen sulfide, often measured in parts per million, ppm. The peak limit is 50 ppm (for up to 10 minutes) and the limit for an 8-hour shift is 10 ppm. Hydrogen sulfide is typically produced from microbial breakdown of organic matter and may be found in biogas extracted from landfills. Hydrogen sulfide may also be found in anerobic digesters which process manure from farms. The liquid sludge in the digesters is treated to remove pollutant from the mixed phase material, and the resulting biogas may be sold as fuel, while the treated manure solids are used in the fields. While biogas may be an environmentally sound approach for generation of methane, hydrogen sulfide must be removed from the biogas prior to its sale and use.

### SUMMARY OF THE INVENTION

The present embodiments include an adsorbent composition to capture hydrogen sulfide from a contaminated medium. For contaminated biogas, hydrogen sulfide may be extracted to produce clean fuel and to prevent the escape of hydrogen sulfide into the atmosphere where it acts as a greenhouse gas. The adsorbent composition disclosed herein is cost effective at removing pollutants including hydrogen sulfide from gas, liquid, or sludge, on the same pollutant removed per gram of adsorbent basis. Additionally, the capture of pollutants is chemical so that the spent adsorbent composition does not require further treatments for disposal.

In some embodiments, an adsorbent composition for capturing pollutants includes a porous composition that includes a plurality of ferric oxyhydroxide particles and an additional component in the porous composition. The additional component includes one of copper chloride (CuCl₂), zinc chloride (ZnCl₂), polyvinylpolypyrrolidone, silicon carbide, silicon dioxide, activated carbon or other carbonaceous material, and a combination thereof.

In some embodiments, an apparatus for capturing pollutants in a gaseous stream includes a housing with an inlet and an outlet, and the adsorbent composition disposed in the housing, such that the gaseous stream is in contact with the adsorbent composition as the gaseous stream flows from the inlet to the outlet.

In some embodiments, an apparatus for capturing pollutants in contaminated liquid includes a chamber with an inlet that receives the contaminated liquid into the chamber, an agitator located inside the chamber, operable to agitate the contaminated liquid, and the adsorbent composition disposed in the chamber, such that the contaminated liquid is in contact with the adsorbent composition.

In some embodiments, a process of capturing hydrogen sulfide in a contaminated feed stream includes providing the contaminated feed stream that includes hydrogen sulfide to an inlet of an adsorption apparatus containing a porous composition comprising ferric oxyhydroxide particles. The process also includes providing optimal contact between the porous composition and the contaminated feed stream to produce treated feed stream. The process also includes allowing the treated feed stream to exit through an outlet of the adsorption apparatus.

In some embodiments, a process of capturing hydrogen sulfide in contaminated liquid includes treating the contaminated liquid that includes hydrogen sulfide using the adsorbent composition comprising ferric oxyhydroxide particles added to the liquid and allowing adsorption to take place between hydrogen sulfide in the liquid and the adsorbent composition. The treated liquid is then extracted from the mixture.

In some embodiments, a process of capturing hydrogen sulfide in sludge contained in an anaerobic digester includes treating the sludge that includes hydrogen sulfide using the adsorbent composition comprising ferric oxyhydroxide particles added to the sludge in the digester with agitation and allowing adsorption to take place between hydrogen sulfide in the sludge and the adsorbent composition. The treated sludge may then be spread into fields, and the generated biogas may be captured for fuel.

### BRIEF DESCRIPTION OF THE FIGURES

FIG. 1 is an illustration of an adsorption apparatus suitable for removing pollutants from a gaseous stream, according to an embodiment.

FIG. 2 illustrates an example gas treatment system utilizing the adsorption apparatus of FIG. 1 for capturing pollutants in a gas stream.

FIG. 3 shows an example anaerobic digester that utilizes the adsorbent composition of FIGS. 1 and 2.

FIG. 4 is a flowchart of a process for capturing hydrogen sulfide in a contaminated feed stream.

### DETAILED DESCRIPTION OF THE EMBODIMENTS

The present embodiments include an adsorbent to capture contaminants including hydrogen sulfide (H₂S) from various forms of contaminated media. The adsorbent, when in contact with contaminated media, captures contaminants including at least one of H₂S, ammonia, and volatile compounds. The absorbent composition is in a solid form, such as a porous composition, that includes ferric oxyhydroxide with at least one additional component. Goethite or a-ferric oxyhydroxide (α-FeOOH) may be used as ferric oxyhydroxide. The additional component may include one or more from a group that includes copper chloride (CuCl₂), zinc chloride (ZnCl₂), polyvinylpolypyrrolidone, silicon carbide, silicon dioxide, activated carbon or other carbonaceous material, and combination thereof. The selection of an additional component is based on the usage. For example, when used in a gaseous stream, the additional component is selected to optimize the flow rate of the gaseous stream. The adsorbent composition may also include iron sulfide. In a usage scenario, the adsorbent may be used as a flow-through medium in contact with the contaminated media.

In certain embodiments, a nominal diameter of ferric oxyhydroxide particles in the adsorbent composition are between 0.1 mm and 5 mm. In certain embodiments, ferric oxyhydroxide particles in the composition have surface area between 20 and 1000 m²/g. Ferric oxyhydroxide particles may make up between 50% and 75% of the total volume of the composition. Additional components may fill between 25% and 50% of the total volume of the composition.

Capturing the contaminants from a medium, such as biogas, may prevent the escape of pollutants including H₂S into the atmosphere where the pollutants act as a greenhouse gas. The adsorbent disclosed herein is cost effective at removing the pollutant from gas, liquid, or sludge, on the same pollutant removed per gram of adsorbent basis. Advantageously, the capture of pollutants is chemical so that the spent adsorbent does not require a further treatment for disposal.

The adsorbent may be contained in a replaceable cartridge, such that a spent adsorbent may be replaced easily. The cartridge may be of any shape to accommodate the existing infrastructure. The adsorbent may be placed in a flow-through medium, such as in a gaseous stream or mixed in when, for example, used to remove pollutant in liquid. The present disclosure includes two example usage of the adsorbent to capture pollutants. The first example captures H₂S from a gaseous stream, and the second example captures H₂S from a sludge in anaerobic digester. As the adsorbent is a versatile porous composition that may be used in a replaceable cartridge or without an enclosure, the usage is not limited to the examples presented.

In the first example, gaseous streams that contain impurities such as H₂S are passed through the adsorbent composite. The contact time between the adsorbent and the gaseous stream is controlled by the flow rate of the gaseous stream and the back pressure resulting from the (controllable) volume of adsorbent that may be in a cartridge. The contact time is adjusted to be sufficient to remove pollutants to an acceptable range. In the case of hydrogen sulfide, the contact time removes all but trace amounts from a stream that typically contains 0.01% to 1% of the target. The gaseous stream to be treated may arise from any source, but of particular interest is landfill biogas. Since the adsorbent removes other unwanted chemicals including ammonia and volatile organic compounds, the resulting biogas may be suitable for use as “clean” fuel.

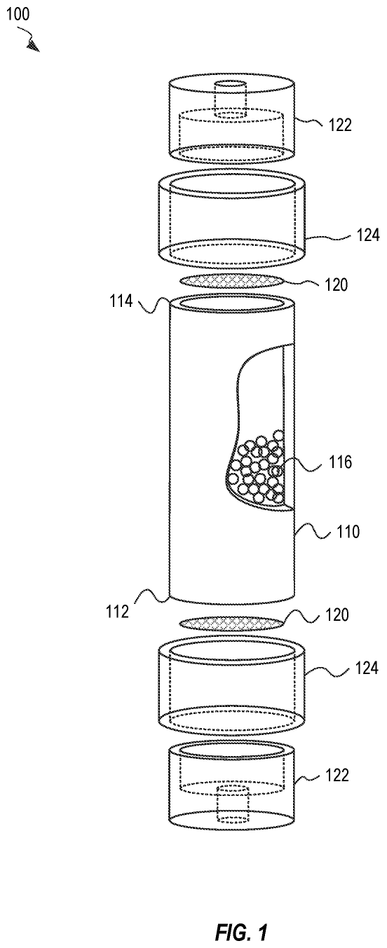

FIG. 1 is an illustration of an adsorption apparatus 100 suitable for removing pollutants from a gaseous stream. The adsorption apparatus 100 includes a main housing 110, adsorbent composition 116, a mesh 120, fittings 124, and taper fittings 122. Taper fittings 122 and fittings 124 may be a national pipe taper (NPT) fitting with fitting sizes selected to fit the existing piping sizes. Mesh 120 may be steel mesh with mesh size suitable to keep the composition 116 within the main housing 110. The main housing 110 may be formed using polyvinylchloride (PVC) or stainless steel and contains composition 116 as shown in a cutout of the main housing 110. In embodiments, main housing 110 has two ends, with one end for incoming gas stream, or an inlet 112, and the other end for exiting gas stream, or an outlet 114. Fittings 124 and taper fittings 122 may have different sizes for inlet 112 and outlet 114, depending at least on existing piping sizes.

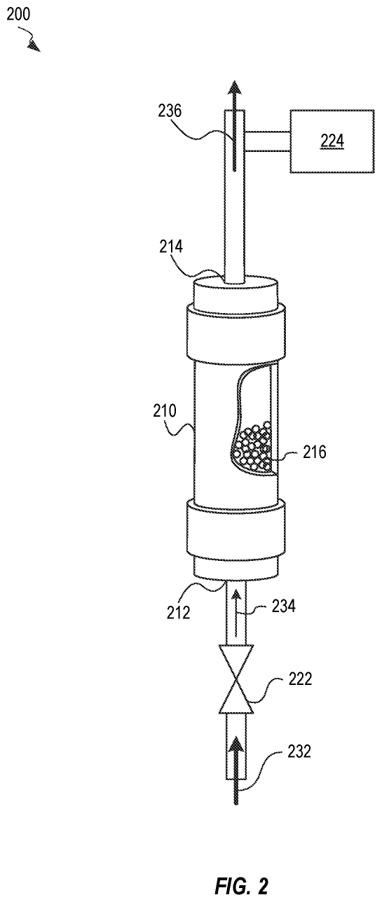

FIG. 2 illustrates an example gas treatment system 200 utilizing the adsorption apparatus 100 of FIG. 1 for capturing pollutants in a gas stream. The treatment system 200 includes an adsorption cartridge 210, which may be a replaceable cartridge version of the adsorption apparatus 100 of FIG. 1. The treatment system 200 also include an untreated gas stream 232, a flow control valve 222, a flow controlled untreated gas stream 234, a treated gas stream 236, and a monitoring unit 224. The adsorption cartridge 210 contains adsorbent composition 216, which is an example of composition 116. In certain embodiments, adsorption cartridge 210 has inlet 212 and outlet 214, which are examples of inlet 112 and outlet 114, respectively.

In certain embodiments, flow control valve 222 controls the flow of untreated gas stream 232 to optimize the contact time between the gas stream and composition 216. Flow controlled untreated gas stream 234 flows into the adsorption cartridge 210 through the inlet 212. Flow controlled untreated gas stream 234 makes contact with the adsorbent composition 216 in cartridge 210. Pollutants including hydrogen sulfide in the gas stream are captured by composition 216 by adsorption process. Treated gas stream 236 with pollutants removed exits the cartridge through outlet 214. Monitoring unit 224 monitors at least the flow rate and the composition of treated gas stream 236. The monitored parameters may be used for controlling the flow control valve 222 to optimize the flow rate.

Typically, untreated biogas stream may contain between 1 and 100 ppm of hydrogen sulfide. In certain embodiments, when the flow rate of the gas stream through the gas treatment system 200 is configured such that gas pressure of 1 to 10 pounds per square inch gauge and the flow rate of 1 to 3 standard cubic feet per hour are maintained, gas treatment system 200 removes between 5 and 290 mmol of hydrogen sulfide per gram of adsorbent composition 216. Other pollutants that may be removed or significantly reduced include ammonia and volatile organic compounds, such that treated gas stream 236 may be used or sold as clean fuel.

In certain embodiments, gas treatment system 200 further includes additional piping, fittings, and valves for easy replacement of a spent cartridge. A spent cartridge 210 may be replaced, and the spent adsorbent composition 216 without further treatment may be safely discarded.

In another example usage of the adsorbent composition, H₂S is also found in anaerobic digesters that process manure from farms. In anaerobic digesters, liquid sludge is treated to remove pollutants from the mixed phase material, and in the process, biogas may be generated. After the digester, while the treated manure solids may be used in the fields, the biogas may further be treated for removal of any remaining pollutants including H₂S.

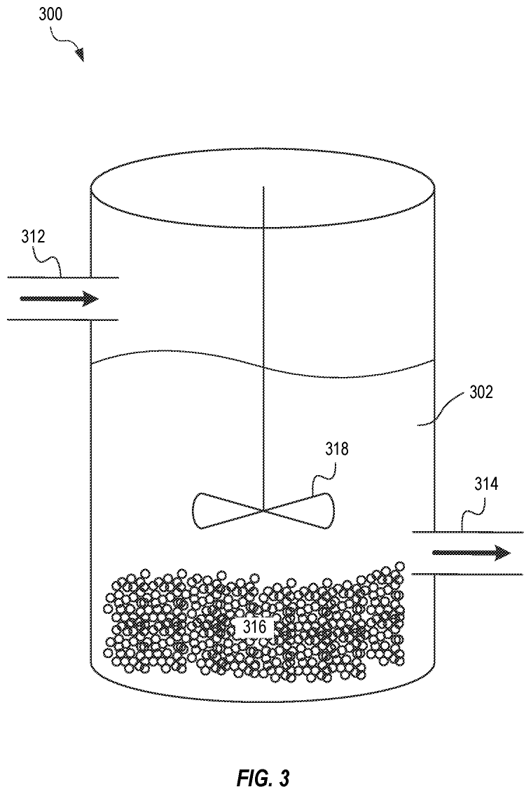

FIG. 3 shows an example anaerobic digester 300 that utilizes an adsorbent composition 316. The composition 316 is an example of the adsorbent composition 116 of FIGS. 1. The adsorbent composition 316 may be in a form of loose porous material emersed in the sludge 302 or may be inside a replaceable cartridge. The anaerobic digester 300 includes an inlet 312 and an outlet 314 for sludge 302. The anaerobic digester 300 may also include an agitator 318. The agitator 318, while shown as a mechanical rotator or agitator in FIG. 3, may also be an agitator jet using gas flow.

In an example use scenario of the anaerobic digester 300, sludge 302 that includes pollutants is entered into the digester 300 via the inlet 312. Inside the digester 300, the sludge 302 is mixed with adsorbent composition 316, where the composition 316 acts as a fining agent to bind with pollutants including H₂S. To help with the mixing process, the mixture may be stirred or vibrated by agitator 318. The agitator 318 may be a mechanical stirrer or an agitator jet that move the mixture by gas flow. The sludge may have a few thousand ppm of H₂S, and the added amount of the adsorbent composition 316 increases to compensate for the expected concentration. The treated sludge is removed from the digester via the outlet 314. The spent adsorbent composition 316 may be replaced, or if the composition is enclosed in a cartridge, the cartridge may be replaced after each usage.

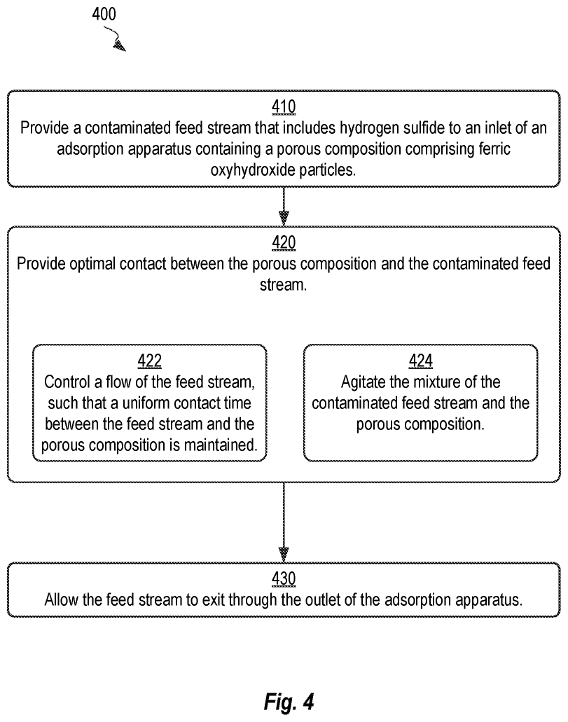

FIG. 4 is a flowchart of a process 400 for capturing hydrogen sulfide in a contaminated feed stream. The contaminated feed stream may include gaseous streams, such as the example of FIG. 2 or liquid or sludge of the example FIG. 3. The process 400 includes steps 410, 420, and 430. The process 400 may include additional implementations, such as any single implementation or any combination of implementations described below and/or in connection with one or more other processes described elsewhere herein.

The step 410 includes providing a contaminated feed stream that includes hydrogen sulfide to an inlet of an adsorption apparatus containing a porous composition comprising ferric oxyhydroxide particles. The contaminated feed stream may be an untreated gaseous stream containing, in part, pollutants including hydrogen sulfide. In some embodiments, the feed stream is a part of biogas treatment system for a landfill. For example, gas treatment system 200 utilizing one or more adsorption cartridge may be a part of a biogas treatment system. Untreated biogas stream, which may contain pollutants including hydrogen sulfide in concentration of 1 to 100 ppm, enters the gas treatment system 200 through the inlet 212 of the adsorption cartridge 210 to be treated for pollutants.

In another example of step 410, the anaerobic digester 300 is fed a contaminated feed stream that is mostly sludge 302 via the inlet 312. The anaerobic digester 300 includes inside the adsorbent composition 316 comprising ferric oxyhydroxide particles. As the sludge 302 is expected to have a higher concentration of H₂S in the range of a few thousand ppm as compared to biogas in the example above, the amount of added adsorbent composition 316 is increased proportionally.

The step 420 includes providing optimal contact between the porous composition and the contaminated feed stream. The step 420 may include a step 422 for inline gaseous stream treatment or a step 424 for liquid or sludge treatment. The steps 422 and 424 may also be used in combination as well. The step 422 includes controlling a flow of the feed stream, such that a uniform contact time between the feed stream and the porous composition is maintained. In an example of step 422, the flow control valve 222 of FIG. 2 controls the flow of the gas stream to optimize the contact time. In this example, the gas monitoring unit 224 monitors the treated gas stream 236 for properties that may include the gas flow rate and the composition of the treated gas stream. The gas monitoring unit 224 may then provide feedback to control the flow rate in a gas treatment system 200 to optimize the contact time. In an embodiment, the flow rate is controlled, such that a pressure of 1 to 100 pounds per square inch gauge and a flow rate of 1 to 3 standard cubic feet per hour for the gas stream passing through the gas treatment system 200 are maintained for adsorption cartridge 210 containing adsorption composition with ferric oxyhydroxide particles making up 50% to 75% in volume.

The step 424 includes agitating the mixture of the contaminated feed stream and the porous composition. In an example of step 424, the sludge 302 in mixture with the adsorbent composition 316 is agitated using the agitator 318. The agitation may include stirring or vibrating the mixture. An agitation jet may also be used to provide forced gas to provide agitation to the mixture. The agitation results in optimizing the contact time between the sludge 302 and the adsorbent composition 316.

The step 420 in both examples provides sufficient contact time, controlled by the flow control valve 222 in step 422 and by the agitation of the sludge mixture in step 424, to allow for optimal adsorption process to take place. In an embodiment, adsorption process allows, in each example, for each gram of adsorbent compositions 216 and 316 to remove 5 to 290 mmol of hydrogen sulfide from a contaminated medium (e.g., the gas stream or sludge) that contains 1 to 1000 ppm of hydrogen sulfide.

The step 430 includes allowing the feed stream to exit through the outlet of the adsorption apparatus. The exiting treated stream contains significantly less or no amount of pollutants including ammonia, volatile organic compounds, and hydrogen sulfide. The treated gas stream may be used or sold as “clean” fuel.

The steps in the process 400 may be repeated to achieve a desired level of pollutants. Additionally, the process 400 in some implementations may include additional steps, fewer steps, different steps, or differently arranged steps than those depicted in FIG. 4. Additionally, or alternatively, two or more of the steps of process 400 may be performed in parallel.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. An adsorbent composition for capturing pollutants, comprising:
a porous composition that includes a plurality of ferric oxyhydroxide particles; and
an additional component in the porous composition;
wherein the additional component is selected from the group consisting of copper chloride (CuCl₂), zinc chloride (ZnCl₂), polyvinylpolypyrrolidone, silicon carbide, silicon dioxide, activated carbon or other carbonaceous material, and a combination thereof

2. The adsorbent composition of claim 1, a diameter of each of the plurality of ferric oxyhydroxide particles being between 0.1 mm and 5 mm.

3. The adsorbent composition of claim 1, a surface area of each of the plurality of ferric oxyhydroxide particle being between 20 and 1000 square meters per gram.

4. The adsorbent composition of claim 1, wherein the plurality of ferric oxyhydroxide particles is between 50% and 75% of a total volume of the porous composition.

5. The adsorbent composition of claim 1, wherein the additional component is between 25% and 50% of a total volume of the porous composition.

6. The adsorbent composition of claim 1, further comprising iron sulfide.

7. The adsorbent composition of claim 1, wherein the adsorbent composition captures at least one of hydrogen sulfide, ammonia, and volatile organic compounds.

8. An apparatus for capturing pollutants in a gaseous stream, comprising:
a housing with an inlet and an outlet; and
the adsorbent composition of claim 1 disposed in the housing, such that the gaseous stream is in contact with the adsorbent composition as the gaseous stream flows from the inlet to the outlet.

9. The apparatus of claim 8, wherein the apparatus is a replaceable cartridge.

10. The apparatus of claim 8, the housing comprising one of polyvinylchloride and stainless steel.

11. The apparatus of claim 8, the apparatus capturing at least one of hydrogen sulfide, ammonia, and volatile organic compounds.

12. The apparatus of claim 8, further comprising:
a gas monitor operable to measure a flow rate of the gaseous stream at the outlet; and
a flow valve, communicatively coupled with the gas monitor, operable to control the flow rate.

13. The apparatus of claim 12, the gas monitor further operable to measure a pollutant concentration of the gaseous stream at the outlet.

14. A process of removing one or more pollutants comprising at least hydrogen sulfide from a contaminated liquid, comprising:
adding the adsorbent composition of claim 1 into the contaminated liquid; and
agitating the contaminated liquid containing the adsorbent composition.

15. The process of claim 14, wherein the contaminated liquid is in an anaerobic digester.

16. The process of claim 14, wherein the pollutants further comprise ammonia, and/or volatile organic compounds.

17. A process of capturing hydrogen sulfide in a contaminated feed stream, comprising:
providing the contaminated feed stream that includes hydrogen sulfide to an inlet of an adsorption apparatus containing a porous composition comprising ferric oxyhydroxide particles;
providing optimal contact between the porous composition and the contaminated feed stream to produce treated feed stream; and
allowing the treated feed stream to exit through an outlet of the adsorption apparatus.

18. The process of claim 17, said step of providing optimal contact including agitating a mixture of the contaminated feed stream and the porous composition.

19. The process of claim 17, said step of providing optimal contact including controlling a flow of the contaminated feed stream, such that a uniform contact time between the contaminated feed stream and the porous composition is maintained.

20. The process of claim 17, further comprising:
removing a spent adsorption apparatus, the spent adsorption apparatus including ferric oxyhydroxide particles saturated with hydrogen sulfide; and
replacing the spent adsorption apparatus.
